(19) United States
(12) Patent Application Publication
(10) Pub. No.: US 2025/0017334 A1
(43) Pub. Date: Jan. 16, 2025

(54) Improved Near Field Communication Ring and Manufacturing Method Thereof

(71) Applicant: ARE CON BETEILIGUNGS-GMBH, Oldenburg (DE)

(72) Inventor: Bernhard Wernberger, Oldenburg (DE)

(21) Appl. No.: 18/712,163

(22) PCT Filed: Nov. 29, 2021
(86) PCT No.: PCT/IB2021/061068

§ 371 Date: May 21, 2024

(51) Int. Cl. A44C 9/00; H04B 5/43

(52) U.S. Cl. CPC A44C 9/0053; H04B 5/43

(57) ABSTRACT

The invention relates to a wearable ring (10) for wearing on a user's finger, the wearable ring (10) comprising an annular base ring (11) having a flat cylindric inner surface (12), a near field communication transponder (5) having a microchip (19) and an antenna (6) mounted on the outer surface (13) of the annular base ring (11), and an outer annular protection means (15; 17) covering the transponder antenna (6) and microchip (19).

### FIELD OF INVENTION

The present invention relates to a wearable NFC ring, in particular a jewelry ring having an NFC radio frequency communication capability in order to be used for various applications including contactless payment, ticketing on mass transit systems, operation of doo locks or other access systems, identity authentication, venue or event entry/ticketing and the sharing of information with NFC-enabled smartphones for example.

### BACKGROUND OF THE INVENTION

Near field communication (NFC) can be used for one- and two-way communication between two devices when held in close proximity to one another, typically within about 3 to 10 cm of one another. The standards defining NFC communications protocols are well known to the skilled person.

Contactless smartcards using NFC or other short range RFID protocols have been in use for many years for applications including access systems to buildings and/or for contactless ticketing on mass transit systems and contactless payment.

More recently, there has been a growing trend to use NFC-enabled smartphones in place of smartcards, especially for contactless payments. Other alternatives to smartcards have also been proposed in recent times, for example using passive/unpowered NFC chips embedded in key fobs, tags, wristbands, rings and labels/stickers.

### PRIOR ART

A near field communication ring is described in WO 2018/020055 A1 (Fifth Dimension Digital Ltd). It includes a ring body having an inner recess in which a transponder antenna and microchip are mounted. The sides of the ring have edges adjacent to the inner recess and extending toward the finger wearing the ring. Therefore, wearing such a ring for a long period of time is not comfortable due to the edges of the ring resting on the finger.

Further, the location and structure of the ring antenna can sometimes lead to an instable communication between the ring and a contactless reader, as the electromagnetic field captured by the ring can be insufficient to warrant a stable communication channel, in particular when the distance between the ring and the reader antenna is equal to or above 3 cm, which can happen for instance when the user has fingers a bit longer than average.

Another drawback of the existing NFC rings lies in the fact that they do not encrypt the data exchanged with a reader, which excludes them from being used in certain applications where the data security is key, such as when personal identification information Is exchanged.

Another drawback lies in the fact that the ring antenna must be mounted onto the inner surface of the ring, which entails a more complex and less reliable manufacturing process.

It is therefore an object of the present invention to propose a new NFC ring design, capable to overcome the drawbacks of NFC rings according to the prior art. It is a particular object of the invention to provide an NFC ring in which the ring body, and the location and structure of the ring antenna, are modified over the prior art and optimized in order to warrant a stable NFC communication channel between the ring and a reader, even when the distance between the ring and the reader antenna is slightly larger than 3 cm.

It is a further object of the present invention to propose an improved manufacturing method in order to produce NFC rings in a more efficient and reliable fashion.

### SUMMARY OF THE INVENTION

In general terms, the present invention proposes an improved near field communication (NFC) ring, and a manufacturing method thereof. The ring can be worn by a user and can communicate with other NFC-enabled devices such as contactless readers, for example to transact a payment, provide personal identification, unlock a door or transfer data.

In particular, the invention proposes a wearable jewelry ring for wearing on a user's finger, the ring comprising an annular base ring having a flat cylindric inner surface, a near field communication transponder having a microchip and an antenna mounted on the outer surface of the annular base ring, and an outer annular protection means covering and protecting the transponder antenna and microchip from damage.

In a first embodiment of the invention, the outer surface of the annular base ring Is provided with an annular outer grove in which the transponder antenna is mounted.

According to such embodiment, the outer protection means is formed by a protection layer made from a hardened sealant liquid positioned in the annular outer grove.

The hardened sealant liquid is a resin seal, for instance a resin seal having a contrasting color respective to the color of the annular supporting shell.

The new structure of the ring also makes it possible to use several types of antennas, which makes the NFC ring more adaptable to the manufacturing processes and to the required communication performance.

According to a first embodiment of the invention, the transponder antenna is a coiled antenna including a plurality of turns.

Alternatively, the transponder antenna is a flat antenna inlay formed by conductive tracks etched on a flexible PCB substrate and the flexible PCB substrate being wrapped around the annular grove of the outer surface of the base ring.

Alternatively, the transponder antenna is a toroidal antenna located in said outer annular grove.

According to another embodiment of the invention, the annular base ring is provided with an outer annular grove or wider recess wherein the transponder antenna and microchip are mounted, and instead of a resin sealant, the outer annular protection means has the shape of an annular outer cover which is manufactured separately and then mounted on the base ring like a tire on a rim and glued on the base ring by a thin layer of glue. Thus, after assembly of the base ring and the outer annular cover, the communication transponder is encapsulated and protected between the base ring and the annular cover.

In one embodiment, the transponder antenna and microchip can be sandwiched between two layers of ferrite mounted into the annular grove or annual recess, in order to improve the radio frequency communication performance of the wearable ring.

In one embodiment, the annular base ring is formed of one of or a combination of a ceramic material, a precious metal, composite plastic, carbon fiber, textile materials, or a natural material such as wood or leather.

The annular cover is a decoration and protection ring made of one or a combination of a precious metal, a colored ceramic, carbon fiber, a ceramic-metal oxide mixture, or natural or painted wood.

The outer annular cover preferably presents one or several features such as a high permeability to electromagnetic fields, a low electrical conductivity, a high scratch-resistance, a high rigidity, a high hardness, a good resistance to moisture, and a pleasing appearance.

According to an embodiment of the invention, the thin layer of glue is made of a waterproof epoxy resin able to protect the transponder from corrosion and moisture and to bind the inner base ring to the annular outer cover in a substantially irreversible manner.

The performance parameters of the transponder antenna such as antenna length or number of turns can be adjusted with additional capacitors according to the base ring diameter in order to ensure a stable data transmission with an external reader, independently of the ring size.

A further object of the present invention relates to a method of manufacturing a wearable ring as described herein, the method comprising:
providing an annular base ring having an annular outer grove;
mounting a near field communication transponder having an annular antenna and a microchip within the annular outer grove, and
applying a protection layer into the outer grove and over the communication transponder in order to seal the grove and encapsulate the transponder. The application of a protection layer may include the application of a liquid sealant resin and curing the resin to harden it.

Alternatively, the method of manufacturing a wearable ring comprises the steps of:
providing an annular base ring having an outer annular grove or recess;
mounting a near field communication transponder having an annular antenna and a microchip within the annular outer recess, and
mounting and gluing an annular outer protection and decoration ring in
order to cover the outer annular recess and transponder.

This second method is particularly advantageous in that it allows to mass produce high volumes of inner rings provided with a transponder, and to separately produce outer cover rings customized according to end customer wishes, as is more appropriate for jewelry rings.

### BRIEF DESCRIPTION OF DRAWINGS

An embodiment of the invention is described below, by way of example, with reference to the accompanying drawings, in which:

FIG. 1 shows a contactless transaction system wherein the transponder is included in a wearable ring in accordance with a first embodiment of the present invention.

FIG. 2 shows in schematic form the structure of a wearable ring according to a first embodiment of the present invention.

FIG. 3 shows a 3D view and a cross section of a base ring of the wearable ring according to the structure of FIG. 2.

FIGS. 4(a), (b) and (c) show the base ring of FIG. 3 with three alternative forms of a transponder antenna that could be used with wearable rings in accordance with embodiments of the present invention.

FIG. 5 shows in schematic form the structure of a wearable ring according to a second embodiment of the present invention.

FIG. 6 shows a 3D view of a base ring an outer cover ring of the wearable ring according to the structure of FIG. 5.

FIGS. 7(a), (b) and (c) show detail cross-sectional views of three alternative forms of a wearable ring according to FIG. 6.

FIG. 8 represents the relative position of a reader antenna and the transponder antenna of the NFC ring according to the invention.

FIG. 9 represents the electromagnetic field during the use of the wearable ring according to the invention for conducting a payment transaction with a contactless payment terminal.

FIG. 10 represents several steps of a method for using the wearable NFC ring according to the invention with a contactless transaction terminal.

### DETAILED DESCRIPTION OF THE INVENTION

In the following description, the invention is exemplified with reference to a contactless payment ring. It will be appreciated, however, that the rings in accordance with embodiments of the invention can be used for other near field communication (NFC) applications, such as ticketing on mass transit systems, operation of NFC door locks or other access systems (e.g., automotive entry systems such as for car doors), identity authentication, event/venue ticketing and the sharing of information with NFC-enabled smartphones for example.

The technical basis for the contactless use of the NFC ring is the RFID technology, or Radio Frequency IDentification technology.

RFID systems are essentially differentiated according to the operating frequency of the reader, the underlying physical coupling process and the communication range of the system.

The RF method works with L-C oscillating circuits which are adjusted to a defined resonance frequency f_{R}. An alternating magnetic field in the RF frequency range is generated by a reader. If the L-C oscillating circuit of the transponder is approached to this magnetic alternating field, energy from the alternating field is coupled into the oscillating circuit of the transponder via the coil of the oscillating circuit (induction law). If the transponder does not have its own power supply, one speaks of a passive transponder. Inductively coupled transponders are operated almost exclusively passively, so that all of the energy required to operate the microchip of the transponder is made available by the reader.

RFID systems are operated on a wide variety of frequencies from long wave (135 kHz) to the microwave range (5.8 GHz). For the physical coupling, electrical, magnetic and electromagnetic fields are used. Ultimately, the achievable range of the systems varies from a few mm to 15 m and more. The relationship between frequency range, reading distance and applicable standards is summarized in the table below.

| | | | |
|---|---|---|---|
| Frequency | Low Frequency (LF) | High Frequency | Ultrahigh frequency |
| range | 124 kHz | (HF) 13.56 MHz | (UHF) 860-960 MHz |
| Reading | Up to 0.1 m | 0.1 m-1 m | For Passive Systems: |
| range | | | up to 18 m |
| Standards | ISO 14223, ISO/IEC | ISO/IEC 14443, | EPCglobal Gen2 (ISO |
| | 18000-2 | ISO 15693, | 18000-6C) |
| | | ISO/IEC 18092, | |
| | | NFC | |

High-end systems for complex and security-relevant applications in the fields of payment, access and e-ticketing are operated almost exclusively on the frequency of 13.56 MHz, which allows a reading range of between 3 and 10 cm based on the field strength. This is a proximity coupling system, the data transmission of which is described and standardized in ISO 14443 ff standard.

The NFC ring according to the invention works on the 13.56 MHz frequency and thus works within the specified performance specification of ISO 14443 ff standard for proximity systems. Other existing RFID transmission and coupling systems will therefore not be discussed in any further detail in the present patent application.

NFC is a special subgroup of the RFID family that, in contrast to RFID, enables communication and data exchange between two devices. It is based on RFID protocols and is therefore a coupling method for RFID. In addition to reading transponders, NFC can also write information. NFC also enables information to be exchanged between two transponder devices. The transfer of data in both directions is one of the special features of NC. This property enables transponder devices that have an integrated NFC chip to be used for contactless payment transactions.

FIG. 1 schematically represents a transaction system 1 comprising a contactless reader terminal 2 connected to a backend databank 3 where the transaction data are stored and processed. The contactless reader 2 includes a reader antenna 4 and can provide energy and clocking to a transponder 5, and exchange data with the transponder 5 via its transponder antenna 6. The transponder 5 in this figure corresponds to the transponder included in the wearable ring according to the present invention. The transponder 5 consists of a microchip (not represented in FIG. 1) connected to the transponder antenna 6.

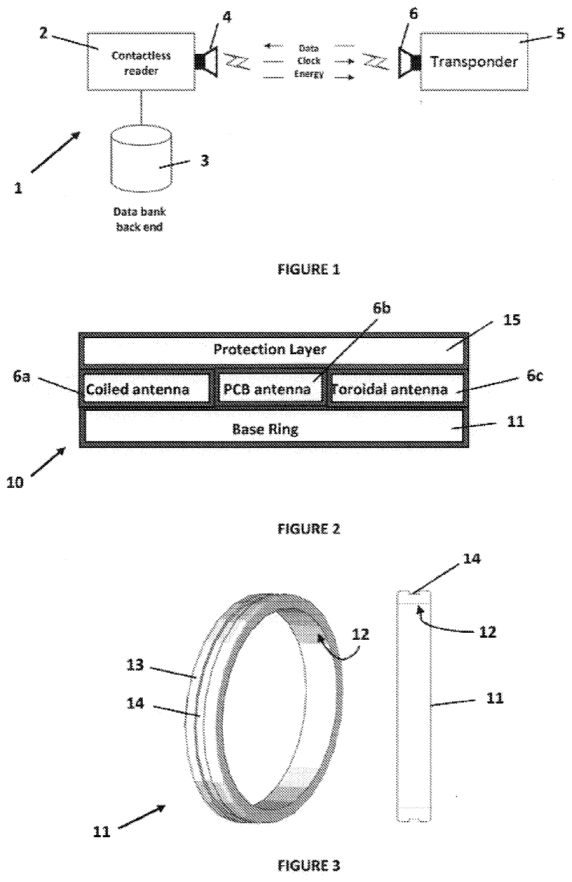

FIG. 2 schematically represents the functional structure of a first embodiment of the wearable ring according to the invention. According to this structure, the ring 10 includes a base ring 11 which is intended to be positioned on a finger of a user. On top of the base ring 11, the NFC ring Includes either one of 3 types of different antennas 6a, 6b or 6c. The antenna 6a, 6b or 6c is then protected by a protection layer 15.

As shown in FIG. 3, the inner surface 12 of the base ring 11 is preferably flat and does not comprise any edges, in order to maximize the comfort of wearing the ring. Further, the outer surface 13 of the base ring 11 presents an outer annular grove 14 which is intended to receive the transponder components, namely an antenna 6 connected to a microchip (not shown in FIG. 3).

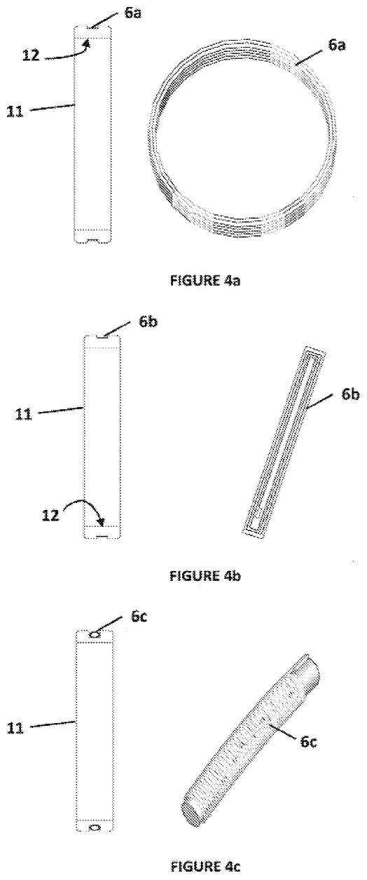

As shown in FIGS. 4a to 4c, the antenna 6 can be implemented in one of several ways, namely in the form of a coiled antenna 6a with windings wrapped around the bottom of the annular grove 14, as shown in FIG. 4A, or an etched antenna 6b as per FIG. 48 obtained by etching a flexible substrate having a metallic layer, or else a toroidal antenna 6c as per FIG. 4C inserted into the grove 14 of the base ring 11. This possibility of choice of an antenna type which is compatible with a unique base ring structure, will enable to maximize the RF communication efficiency, based on other parameters such as finger size and ring diameter.

Once the transponder 5 is positioned in the grove 14 of the base ring 11, a liquid sealant 15 (as schematically represented in FIG. 2, and not represented in FIGS. 3-4) is poured into the grove 14 and cured in order to harden it, whereby the transponder 5 is protected airtight against tampering or other damage or environmental conditions.

The man skilled in the art can easily find the most appropriate sealant material 15 for each environment or use case of the ring. Examples of materials that can be an appropriate sealant include resins preferably selected to have an inert nature, to have attractive appearance and to be scratch resistant. Other features such as non-toxicity may be relevant. Examples of usable sealants may thus include two-component resins including the resin itself (e.g., a Bisphenol-A based epoxy, containing Polyglycidyl Ether) and a hardener (e.g. Including a Cycloaliphatic Polyamine). The sealant 15 may be transparent, or colored. It may be one that is specifically intended for use in jewelry and the decorative arts industries. Alternatively, the sealant resin 15 may itself be covered by an external metallic ring, such as a gold or platinum ring superposed over the sealant in order to improve the value and appearance of the NFC ring.

The solid base ring 11 can be made from a wide variety of materials, such as, without limitation, wood, ceramics, precious metal, leather, composite materials, carbon fiber. The important thing here is that an annular grove 14 can be made non-destructively in the base ring body in such a way that a suitable transponder antenna 6 can be accommodated and no mechanical weakness or breaking point arises.

The ring structure according to FIGS. 2 to 4 offers maximum flexibility when choosing the desired base ring body material. This is why organic materials such as leather and textile composites can also be used.

The durability of the individual material options in terms of longevity is not the primary subject of this patent specification, since this also depends on proper and careful use by the ring bearer. However, the materials listed above all prove to be suitable, in conjunction with a correctly selected antenna, to meet the required product standards in accordance with ISO 14443 and CQM.

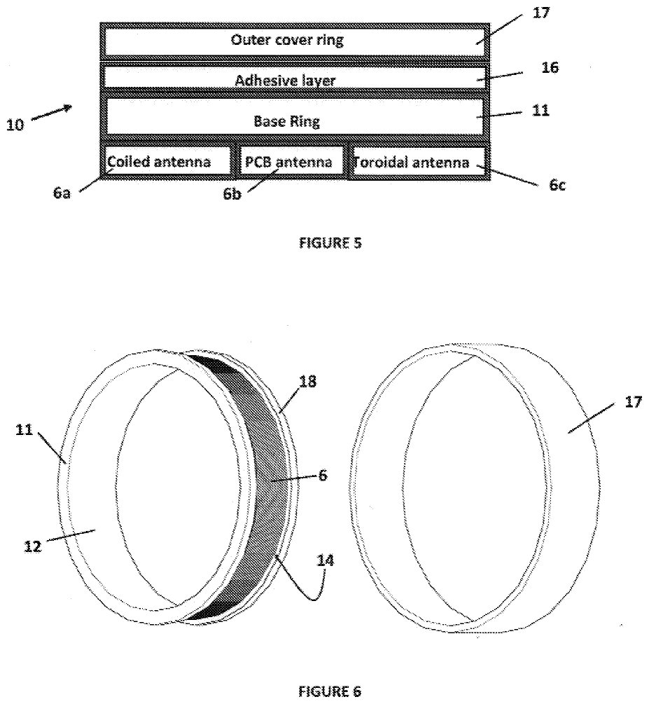

FIG. 5 schematically represents the functional structure of a second embodiment of the wearable NFC ring 10 according to the invention. The ring 10 again includes a base ring 11 similar to the one of the first embodiment. However, the outer surface of the base ring 11 again presents an annular grove or recess 14 which is intended to receive the transponder components, namely the antenna 6 connected to a microchip (not represented). The antenna 6 can be implemented in the same ways as in the first embodiment, namely a coiled antenna 6a with windings wrapped around the bottom of the annular grove 14 (FIG. 4A), or a toroidal antenna 6c as per FIG. 4C inserted into the grove, or else an etched antenna 6b as per FIG. 4B obtained by etching a flexible substrate having a metallic or otherwise electrically conductive layer.

However, in this second embodiment, the protective sealant 15 of the previous embodiment is replaced by an external ring 17 manufactured separately and which is positioned on the base ring 11 in the same fashion a tire is positioned on a rim. The external ring 17 or cover ring is glued onto the outer edges 18 of the base ring 11 by a specific glue. The gluing can be reversible or irreversible, depending on whether the cover ring 17 should be replaceable or not. The cover ring 17 is however preferably glued irreversibly, meaning that from a user perspective, it cannot be removed (although it would always be possible to remove it by using professional disassembling procedures such as using acetone or equivalents to dissolve the glue).

The NFC ring 10 thus consists of an inner ring or base ring 11, i.e. “the rim”, which contains the functional components (namely the transponder 5 including a chip system and antenna) and an outer ring 17, serving as a cover for protection and decoration, i.e. “the tire”. The cover ring 17 is non-functional and primarily serves for visual individualization. It can also be designed with a free, ad hoc shape on its outside, for instance with engravings or equivalent. An actual embodiment of this second ring structure according to FIG. 5 is shown in FIG. 6, before assembly and without the glue.

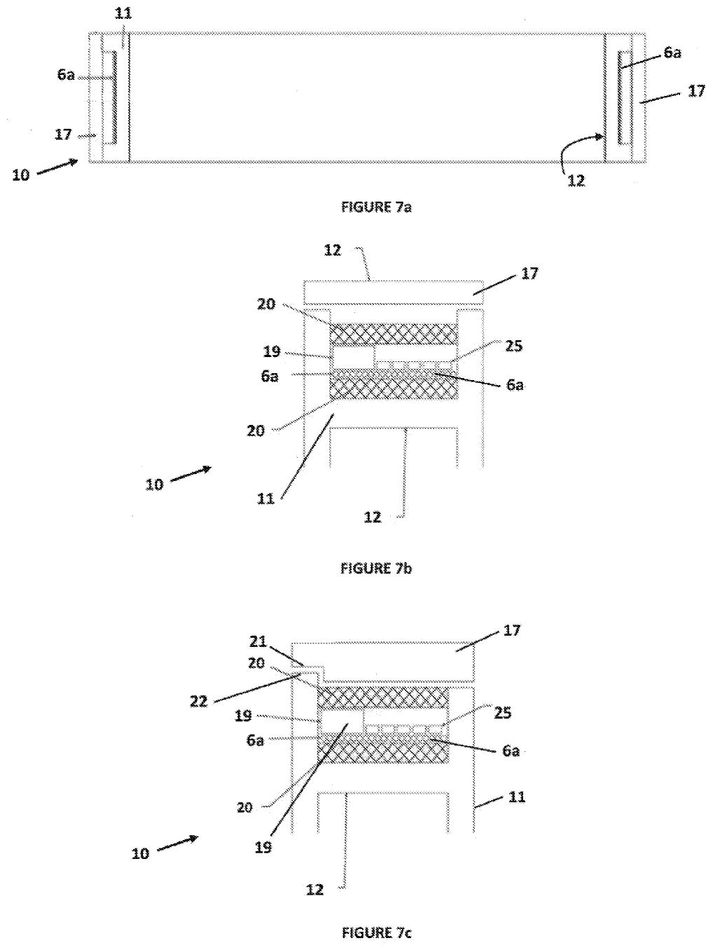

FIGS. 7A to 7C show partial views of a cross-section of an NFC ring 10 according to variants of the second embodiment, after assembly of the outer ring 17 onto the base ring 11. In FIG. 7A, the transponder includes a coiled antenna 6a directly wound onto the bottom of the annular recess 14 of the base ring 11. FIG. 76 is similar to FIG. 7A, however the transponder components, namely the antenna 6a and the microchip 19, (and optionally some capacitors 25 used to adjust the resonance frequency) are sandwiched between two ferrite layers 20, which have the capability to improve the radiofrequency performance of the ring by minimizing electromagnetic losses, especially when the base ring 11 or outer ring 17 are made of a metallic material. FIG. 7C is similar to FIG. 78, except that the inner surface of the outer ring 17 presents a local recess 21 on the left side that nudges against an outer edge 22 of the base ring 11. Such a structure may be advantageous, as it enables to easily slide and position the outer ring 17 onto the base ring 11 during the NFC ring assembly process.

Due to this modular product structure with two rings 11, 17, it Is also possible to manufacture the NFC ring in a two-stage, time-independent manufacturing process, namely manufacture large batches of base rings 11 provided with their transponder, and separately manufacture one-off or small batches of outer cover rings 17 based on specific customer requirements. This fact favors the economy of the manufacturing process as well as the flexibility of the product variants, especially with regard to the possible material combinations.

During ring assembly, a transparent and adhesive, waterproof epoxy resin is used to protect the transponder 5 and to glue together the base ring 11 with its transponder 5 and the outer protection and decoration ring 17. This protects the transponder from corrosion caused by moisture and air pockets. In addition, the glue or epoxy resin promotes the attenuation behavior of the antenna.

It is to be noted that the chipset and the connection technology to the antenna are not the subject of the present invention, and are not further described as they are well known in the art.

However, it might be worthwhile to note that a preferred embodiment of the NFC ring according to the invention may use a high end microchip provided with an encryption function in order to encrypt and secure sensitive data to be exchanged between the contactless reader and the NFC ring.

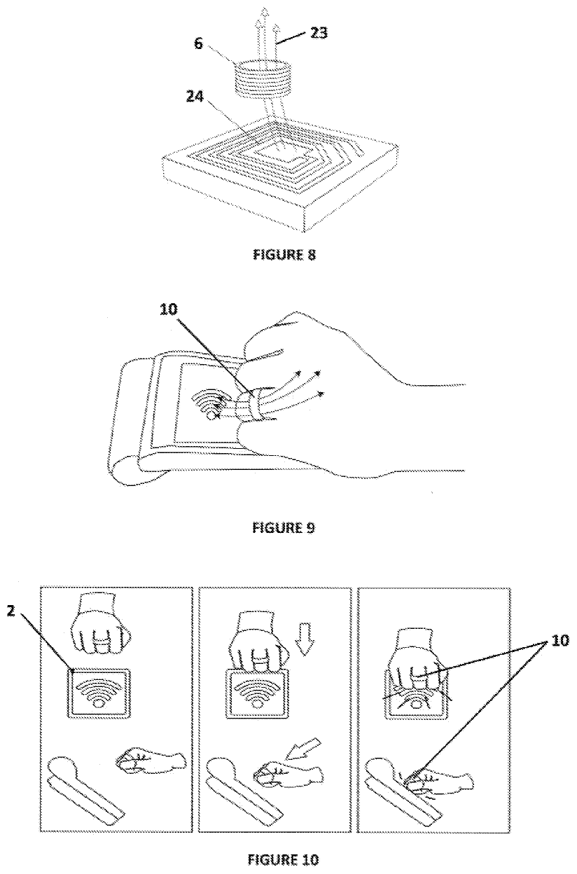

As already known to the man skilled in the art, the design of a transponder and in particular the parameterization of antenna wire thickness, antenna diameter, the number of antenna turns and the distance between the wire windings determine the data transmission properties of the RFID system to a very large extent FIG. 8 shows the flux lines 23 of the magnetic field generated by a reader antenna 24, as they cross the antenna 6 of the NFC wearable ring according to the invention, whereby an electric current is generated within the ring antenna 6. The corresponding power will then be used to power the transponder microchip. The inductively generated current in the NFC ring antenna will increase when the ring antenna 6 is approached of the reader antenna 24 and the turns of both antennas 6, 24 are substantially parallel, i.e. when the axis of the NFC ring antenna 6 is perpendicular to the reader antenna 24. This orientation is best achieved, as shown in FIGS. 9 and 10, when the person wearing the ring 10 uses a knocking-type action with the ring-wearing finger flexed, a very simple and natural gesture.

The NFC ring 10 according to the invention is worn on a finger like a jewelry ring. It doesn't matter which finger the ring is worn on. The ring size is based exclusively on the wearing comfort of the user.

As a prerequisite for the planned use of the NFC ring 10, the desired application such as a payment application (e.g. Mastercard applet) must be property loaded and installed in the chipset of the NFC ring.

If the user then approaches the NFC ring-wearing finger from an authorized HF RFID reader 2 (e.g. payment terminals at checkout systems, shops or restaurants) such as shown in the left and central parts of FIG. 10, he brings the ring 10 into the magnetic alternating field of the reader 2 and the NFC ring is supplied with energy. When the distance between the NFC ring 10 and the reader 2 is in the range of around 3 cm, such as when the user taps the reader surface as represented in the right part of FIG. 10, the distance is optimal for an NFC communication between the ring 10 and the reader 2. This enables data communication and starts the application-specific data transfer for the payment process.

During the data transfer of the payment process, but also in the context of other applications, the hand must be held steady and stable for a very short time, until the transaction is completed. Otherwise, the application cannot rule out transaction aborts. However, these are not due to the properties of the NFC ring itself, but are viewed as operating errors.

In addition to the already mentioned relevance of the antenna dimensioning and the parameterization of the transponder, the inclination of the transponder antenna 6 in relation to the antenna 24 of the reader also plays an important role for optimal data transmission in the RFID system. Depending on the angle of inclination at which the ring carrier positions its NFC ring for the payment process or other transaction to the reader, there may be slight reductions or changes in the achievable reading distance to the reader.

### Advantages of the Invention

The new wearable NFC ring structure described herein achieves the desired goals.

The various ring structures and three dimensional antenna designs allow the antenna to be fine tuned and adapted to any practical wearable ring size.

The available combinations of materials used for the base ring and the protection sealant allow both to optimize the data transmission properties and the cosmetic aspect of the NFC ring.

Depending on the required ring size, the performance parameters of the transponder antenna can be easily trimmed for optimal data transmission. This ensures that stable data transmission in accordance with the product specification can be achieved for each ring size.

Finally, the manufacturing methods according to the invention allow to manufacture the wearable NFC ring according to the invention in a cost effective and reliable fashion.

1. A wearable ring for wearing on a user's finger, the wearable ring comprising:
an annular base ring having a flat cylindric inner surface;
a near field communication transponder having a microchip and an antenna mounted on the outer surface of the annular base ring; and
an outer annular protection means covering the transponder antenna and microchip, wherein the outer surface of the annular base ring is provided with an annular outer grove in which the transponder antenna and the microchip are mounted, and wherein the transponder antenna and the microchip are sandwiched between two layers of ferrite mounted into the annular grove of the base ring.

2. The wearable ring according to claim 1, wherein the outer protection means is formed by a protection layer made of a hardened sealant liquid positioned in the annular outer grove of the base ring.

3. The wearable ring according to claim 2, wherein the hardened sealant liquid is a resin seal, having a contrasting color or an identical color respective to the color of the annular base ring.

4. The wearable ring according to claim 1, wherein the transponder antenna is a coiled antenna including a plurality of turns.

5. The wearable ring according to claim 1, wherein the transponder antenna is a flat antenna inlay formed by conductive tracks etched on a flexible PCB substrate and the flexible PCB substrate being wrapped around the annular outer grove of the base ring.

6. The wearable ring according to claim 1, wherein the transponder antenna is a toroidal antenna positioned into the annular outer grove of the base ring.

7. The wearable ring according to claim 1, wherein the outer annular protection means has the shape of an annular outer cover mounted on the base ring like a tire on a rim and glued on the base ring by a thin layer of glue, the communication transponder being encapsulated and protected between the base ring and the annular outer cover.

8. The wearable ring according to claim 1, wherein the annular base ring is formed of a ceramic material, a precious metal, composite plastic or textile materials, a natural material, wood, or leather.

9. The wearable ring according to claim 7, wherein the annular outer cover is a decoration and protection ring made of a precious metal, a colored ceramic, a ceramic-metal oxide mixture, or natural or painted wood.

10. The wearable ring according to claim 7, wherein the thin layer of glue is made of a waterproof epoxy resin able to: protect the transponder from corrosion and moisture and bind the inner base ring to the annular outer cover.

11. The wearable ring according to claim 1, wherein the performance parameters of the transponder antenna are adjusted with additional capacitors according to the base ring diameter to provide a stable data transmission with an external contactless reader independent of the wearable ring size.

12. The wearable ring according to claim 1, wherein the transponder microchip includes an encryption function in order to encrypt and secure sensitive data to be exchanged between the contactless reader and the wearable ring.

13. The wearable ring according to claim 7, wherein the inner surface of the outer ring presents a local recess on one of its sides and the local recess nudges against an outer edge of the base ring.

14. A method of manufacturing the wearable ring according to claim 2, the method comprising:
providing the annular base ring having the annular outer grove;
mounting the near field communication transponder having the annular antenna and the microchip within the annular outer grove; and
applying the protection layer to cover the outer grove and the communication transponder in order to seal the outer grove of the base ring and encapsulate the transponder.

15. The method according to claim 14, wherein applying the protection layer comprises applying a liquid sealant resin and curing the resin to harden the resin.

16. A method of manufacturing the wearable ring according to claim 7, the method comprising:
providing the annular base ring having the outer annular grove;
mounting the near field communication transponder having the annular antenna and the microchip into the annular outer grove; and
mounting and gluing the annular outer cover over the outer annular grove.
